(19) United States
(12) Patent Application Publication
(10) Pub. No.: US 2009/0015999 A1
(43) Pub. Date: Jan. 15, 2009

(54) Housing for a display device

(75) Inventor: Chien-Tsai Chueh, Hsinchu (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Coretronic Corporation, Hsinchu (TW)

(21) Appl. No.: 12/012,093

(22) Filed: Jan. 30, 2008

(30) Foreign Application Priority Data
Jul. 10, 2007 (TW) 096125047

(51) Int. Cl. G06F 1/16

(52) U.S. Cl. 361/681

(57) ABSTRACT

A housing for a display device includes a base housing part and a rear housing part. The rear housing part is installed on the base housing part and defines a receiving space. The rear housing part has a lower side portion, a recess portion formed in the lower side portion, at least one air inlet hole, an upper side portion, and a plurality of air outlet holes formed in the upper side portion. The recess portion has a first wall and a second wall relative to the first wall. The air inlet hole is formed in one of the first wall and the second wall, and is in fluid communication with the air outlet holes. The construction as such may increase air inflow and enhance the heat dissipating effect.

### CROSS-REFERENCE TO RELATED APPLICATION

This application claims priority of Taiwanese application no. 096125047, filed on Jul. 10, 2007.

### BACKGROUND OF THE INVENTION

1. Field of the Invention

The invention relates to a display device, more particularly to a housing for a display device, the housing having a good heat dissipating effect and being capable of reducing mold design and manufacturing costs.

2. Description of the Related Art

FIG. 1 illustrates a housing 1 for a flat panel display device, such as a liquid crystal display, a liquid crystal television or a plasma television. The housing 1 has bottom walls 11 disposed at two opposite sides of a bottom portion and formed with circular air inlet holes 12. Air outside the housing 1 may enter the housing 1 through the air inlet holes 12 so that hot air generated during operation of electronic components (not shown) or a circuit board (not shown) inside the housing 1 is discharged through air discharge holes 14 formed in a rear side plate 13 to achieve a heat dissipating effect. However, in view of safety considerations, the hole diameter of the air inlet holes 12 is designed to be smaller than 2 millimeters to prevent damaged or burnt out electronic components inside the housing 1 from falling out of the housing 1 through the bottom walls 11.

To form the air inlet holes 12 in the bottom walls 11 of the housing 1, it is required to design a mold (not shown) having protruding studs so that the air inlet holes 12 are punched in the bottom walls 11 of the housing 1 through the protruding studs during a punching operation using the mold. However, because of the restriction in the design of the hole diameter of the air inlet holes 12, the outer diameter of the protruding studs of the mold is designed to be smaller than 2 millimeters. Accordingly, the protruding studs easily break due to insufficient strength during a punching operation using the mold, thereby resulting in a short service life of the mold and thereby increasing costs associated with using the mold. In addition, since the hole diameter of the air inlet holes 12 is small, the amount of air inflow is relatively low, and the heat dissipating effect is unsatisfactory.

### SUMMARY OF THE INVENTION

Therefore, the present invention provides a housing for a display device, the housing having a good heat dissipating effect and being capable of reducing mold design and manufacturing costs.

Other objects and advantages of the present invention will become apparent from the technical features disclosed by the present invention.

In order to achieve one of or a portion of or all of the above objects or other objects of the present invention, a housing for a display device according to a preferred embodiment of the present invention includes a base housing part and a rear housing part. The rear housing part is installed on the base housing part and defines a receiving space. The rear housing part includes a recess portion formed in a lower side portion of the rear housing part, at least one air inlet hole, and a plurality of air outlet holes formed in an upper side portion of the rear housing part. The recess portion has a first wall and a second wall relative to the first wall. The air inlet hole is formed in one of the first wall and the second wall, and is in fluid communication with the air outlet holes.

In the housing for a display device according to this invention, a top end portion of a first wall and a top end portion of a second wall are cut such that the top end portion of the first wall and the top end portion of the second wall cooperate with two opposite end portions of a third wall to define two air inlet holes; a top end portion of a first wall and a top end portion of a second wall are respectively connected to two opposite end portions of a third wall, and two air inlet holes are respectively formed in the first wall and the second wall; or a top end portion of a first wall and a top end portion of a second wall are respectively connected to two opposite end portions of a third wall and respectively cooperate with the two opposite end portions of the third wall to define two air inlet holes. Since the designs of the air inlet holes are not restricted by safety considerations, the holes may be designed to be larger so as to increase air inflow and enhance the heat dissipating effect. In addition, the designs of the air inlet holes may reduce mold design and manufacturing costs, or prolong the service life of a mold.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The above and other technical contents, features and effects of the present invention will become apparent in the following detailed description of three preferred embodiments with reference to the accompanying drawings, of which:

FIG. 1 is a perspective view of a conventional housing for a display device;

FIG. 2 is a perspective view of a first preferred embodiment of a housing for a display device according to the present invention;

FIG. 3 is an exploded perspective view of the first preferred embodiment;

FIG. 4 is a perspective view of the first preferred embodiment viewed from another angle;

FIG. 5 is a rear schematic view of the first preferred embodiment, illustrating how air outside the housing may flow into a receiving space through air inlet holes and may be discharged through air outlet holes;

FIG. 6 is a perspective view of a modification of the first preferred embodiment;

FIG. 7 is a perspective view of a second preferred embodiment of a housing for a display device according to the present invention;

FIG. 8 is a perspective view of a modification of the second preferred embodiment;

FIG. 9 is a perspective view of a third preferred embodiment of a housing for a display device according to the present invention; and

FIG. 10 is a perspective view of a modification of the third preferred embodiment.

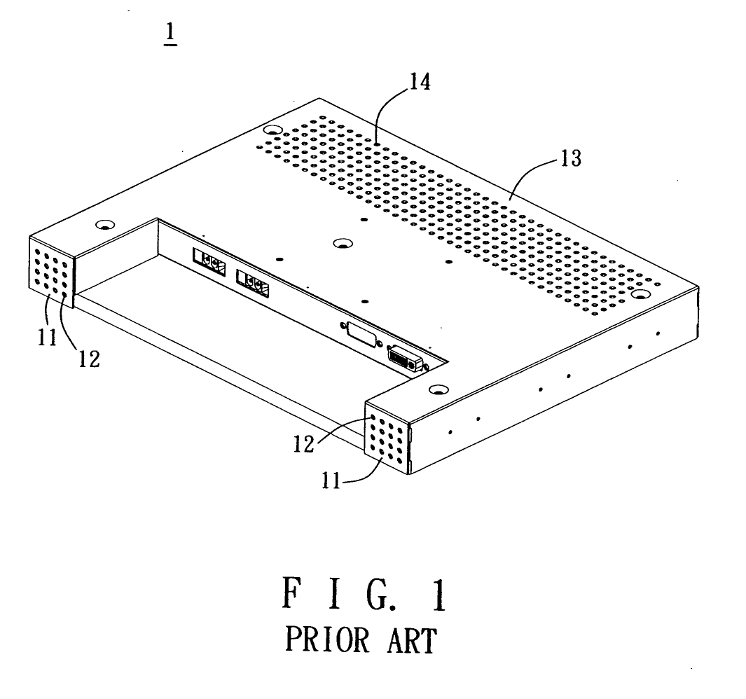

### DETAILED DESCRIPTION OF THE PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising, ” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component faces “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

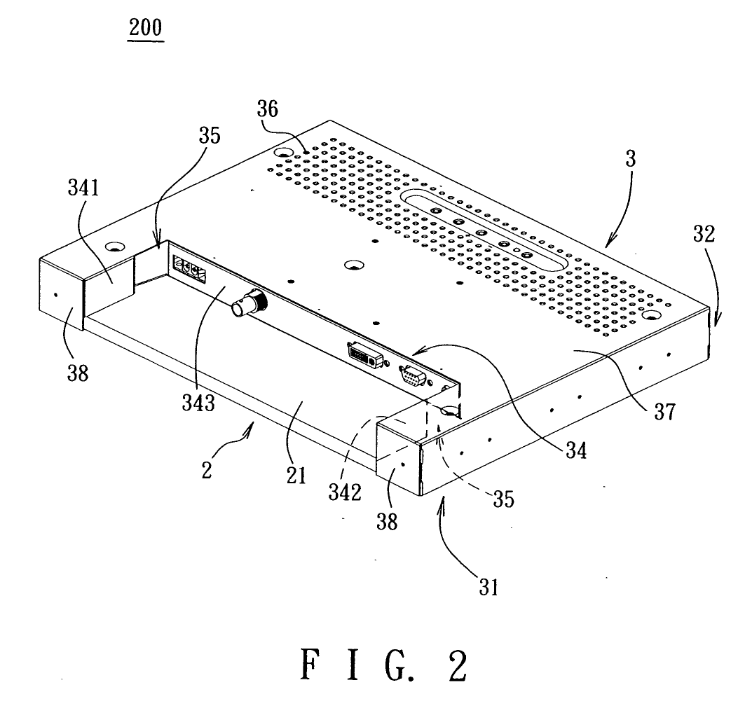

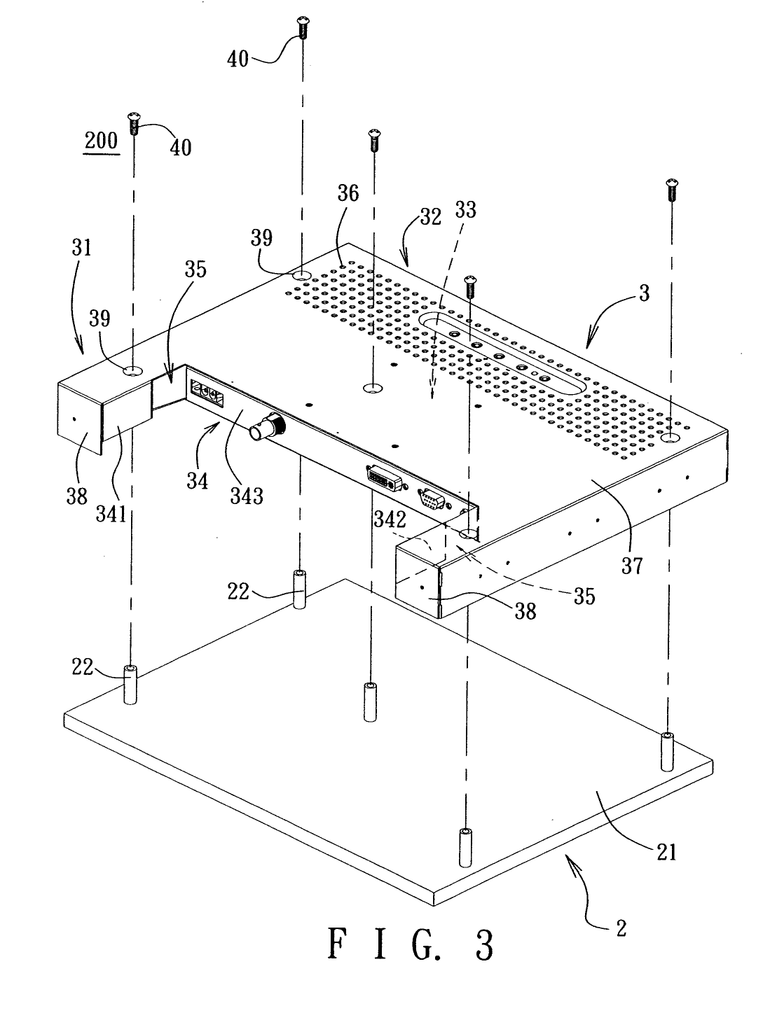

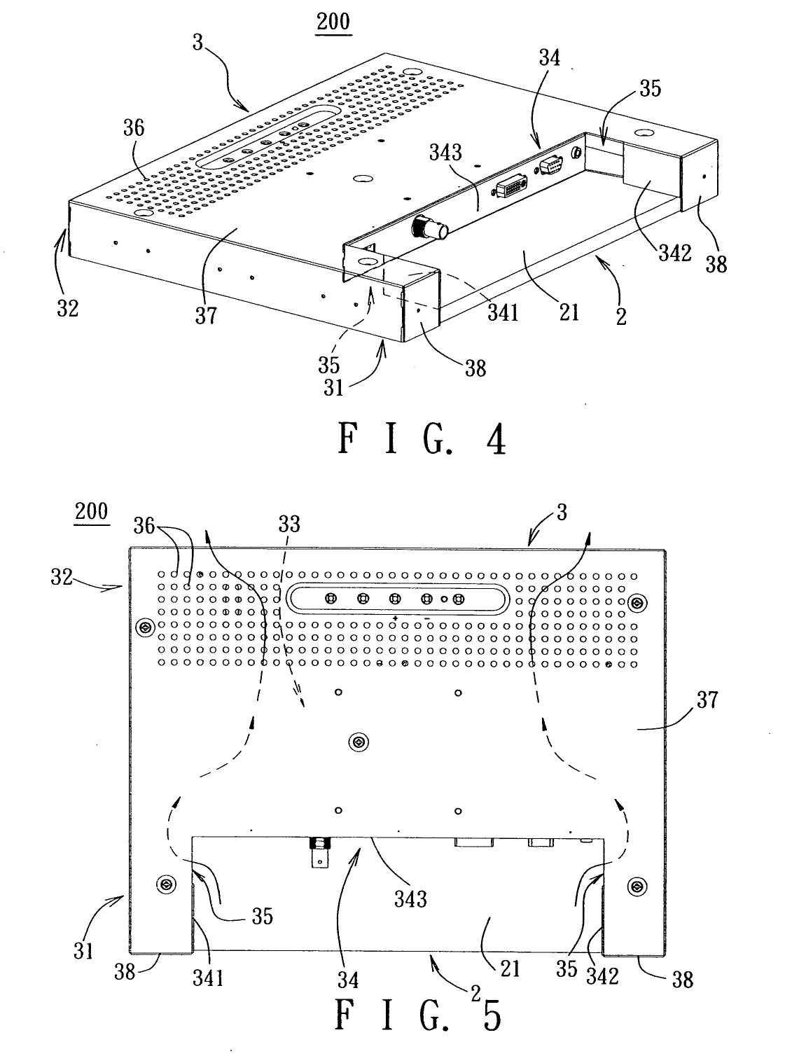

Referring to FIG. 2, FIG. 3 and FIG. 4, a first preferred embodiment of a housing 200 for a display device is shown. The housing 200 is made of metal, and is primarily applied to a flat panel display device, such as a liquid crystal display, a liquid crystal television or a plasma television. The housing 200 includes a generally rectangular base housing part 2 and a rear housing part 3 installed on the base housing part 2.

The base housing part 2 includes a generally rectangular base plate 21 and a plurality of positioning studs 22 that extend from the base plate 21 toward the rear housing part 3.

The rear housing part 3 has a lower side portion 31, an upper side portion 32, a receiving space 33 defined by the lower side portion 31 and the upper side portion 32, a recess portion 34 formed in the lower side portion 31, two air inlet holes 35, and a plurality of air outlet holes 36 formed in the upper side portion 32. The recess portion 34 is generally inverted U-shaped, and has an opening that faces downwardly. The recess portion 34 has a first wall 341, and a second wall 342 relative to the first wall 341. The recess portion 34 further has a third wall 343 that faces toward the opening and that is connected to the first wall 341 and the second wall 342. In particular, the first wall 341 and the second wall 342 are disposed transverse to the base plate 21 and extend in a direction perpendicular to an extension direction of the third wall 343. The first wall 341 and the second wall 342 are respectively disposed at positions corresponding to two opposite end portions of the third wall 343. In this embodiment, the first wall 341 and the second wall 342 are respectively spaced apart from the two opposite end portions of the third wall 343 and respectively cooperate with the two opposite end portions of the third wall 343 to define the two air inlet holes 35. Each of the air inlet holes 35 is generally rectangular and is in fluid communication with the air outlet holes 36 through the receiving space 33.

In addition, the rear housing part 3 includes a rear sidewall 37, two bottom walls 38, a plurality of fastener holes 39, and a plurality of screw fasteners 40. The rear side wall 37 is generally inverted U-shaped with an opening that faces downwardly, and defines a portion of the lower side portion 31 and a portion of the upper side portion 32. The bottom walls 38 are respectively formed at two bottom ends of the rear side wall 37. The air outlet holes 36 are formed in the rear side wall 37 proximate to a top edge of the rear side wall 37. The fastener holes 39 are formed in the lower side portion 31 and the upper side portion 32 of the rear housing part 3.

When installing the rear housing part 3 on the base housing part 2, the rear housing part 3 is disposed to cover a top edge, two side edges and a portion of a bottom edge of the base plate 21 of the base housing part 2. At the same time, the first wall 341, the second wall 342 and the third wall 343 are disposed transverse to the base plate 21. The screw fasteners 40 are respectively extended through the fastener holes 39 and are threaded into the positioning studs 22 on the rear side face of the base plate 21 to complete installation of the rear housing part 3 on the base housing part 2.

Referring to FIG. 2, FIG. 4 and FIG. 5, during operation of a circuit board (not shown) or electronic components (not shown) installed in the receiving space 33 of the rear housing part 3, air outside the housing 200 enters the receiving space 33 of the rear housing part 3 through the two air inlet holes 35, and hot air generated during operation of the circuit board or the electronic components is discharged through the air outlet holes 36 in the rear side wall 37 of the rear housing part 3, thereby achieving a heat dissipating effect. Since the sizes of the two air inlet holes 35 are respectively defined by a clearance between a corresponding one of a top end portion of the first wall 341 and a top end portion of the second wall 342 and a corresponding one of the two opposite end portions of the third wall 343, and since the first wall 341 and the second wall 342 are respectively formed to extend a certain distance from a corresponding inner side of the rear side wall 37, followed by forward bending of the same, the sizes of the air inlet holes 35 may be defined in design by cutting the top end portion of the first wall 341 and the top end portion of the second wall 342. Aside from the sizes of the air inlet holes 35 being larger than the air inlet holes disclosed in the prior art, the design is also not restricted by safety considerations, and air inflow into the receiving space 33 through the air inlet holes 35 may be increased to enhance the quality of heat dissipation.

Through cutting of the top end portion of the first wall 341 and the top end portion of the second wall 342, followed by a bending step, the top end portion of the first wall 341 and the top end portion of the second wall 342 may cooperate with the two opposite end portions of the third wall 343 to define the two air inlet holes 35. Therefore, there is no need to additionally design a mold to form the air inlet holes as required in the prior art. This method of design may avoid costs incurred in forming the additional mold. On the other hand, since the bottom walls 38 are not formed with the air inlet holes, and since bottom end portions of the first wall 341 and the second wall 342 respectively abut against inner sides of the two bottom walls 38, damaged or burnt out electronic components may be prevented from falling out of the housing 200.

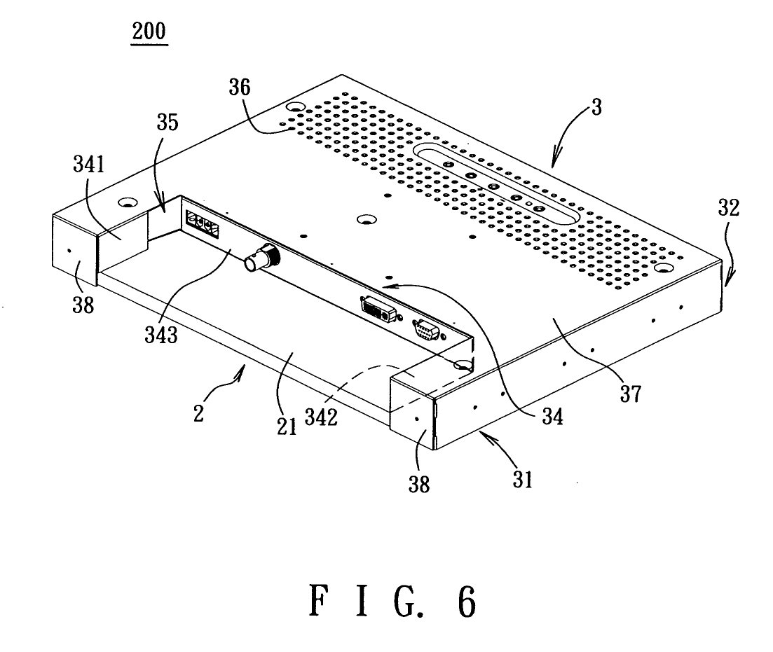

FIG. 6 shows a modification of the first preferred embodiment. The housing 200 of FIG. 6 is similar to that shown in FIG. 2, the main differences residing in that there is only one air inlet hole 35 in the rear housing part 3 of FIG. 6, a top end portion of one of the first wall 341 and the second wall 342 is connected to the third wall 343, a top end portion of the other one of the first wall 341 and the second wall 342 is not connected to the third wall 343, and the one of the first wall 341 and the second wall 342 that is spaced apart from the third wall 343 cooperates with the third wall 343 to define the air inlet hole 35. In particular, the air inlet hole 35 may be defined by the top end portion of the first wall 341 and one end of the third wall 343, or by the top end portion of the second wall 342 and the other end of the third wall 343. In FIG. 6, the top end portion of the second wall 342 is connected to the third wall 343, the top end portion of the first wall 341 does not contact the third wall 343, and the air inlet hole 35 is cooperatively defined by the top end portion of the first wall 341 and one end of the third wall 343.

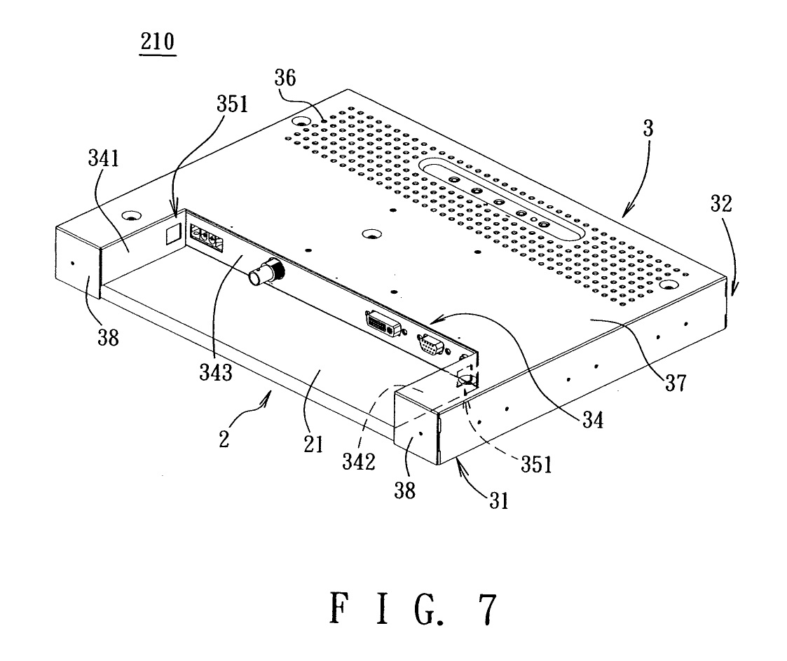

FIG. 7 illustrates a second preferred embodiment of a housing 210 for a display device according to the present invention. The overall construction of the housing 210 is generally similar to that of the first preferred embodiment. However, the design of the two air inlet holes 351 differs from that of the first preferred embodiment. In this embodiment, the two air inlet holes 351 are respectively formed in the first wall 341 and the second wall 342 and are formed by punching. A top end portion of the first wall 341 and a top end portion of the second wall 342 are respectively connected to two opposite end portions of the third wall 343. In view of the large hole dimensions and simple design of the air inlet holes 351, the design of the outer dimensions of protruding studs (not shown) of a mold (not shown) for punching the air inlet holes 351 is not unduly restricted. Compared to the prior art, the protruding studs are stronger, such that the service life of the mold is longer. The air inlet holes 351 may be circular or may be formed in other shapes and are not limited to the shape disclosed in the drawing.

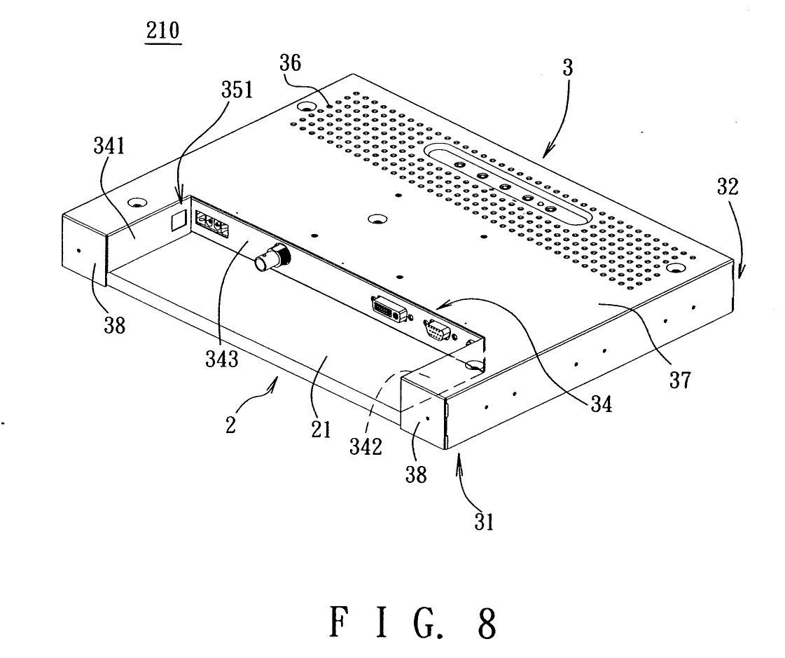

FIG. 8 illustrates a modification of the second preferred embodiment. The housing 210 of FIG. 8 is similar to that of FIG. 7, the main differences residing in that there is only one air inlet hole 351 in the rear housing part 3 of FIG. 8, and the air inlet hole 351 is formed in one of the first wall 341 and the second wall 342. The air inlet hole 351 is formed in the first wall 341 in the embodiment of FIG. 8.

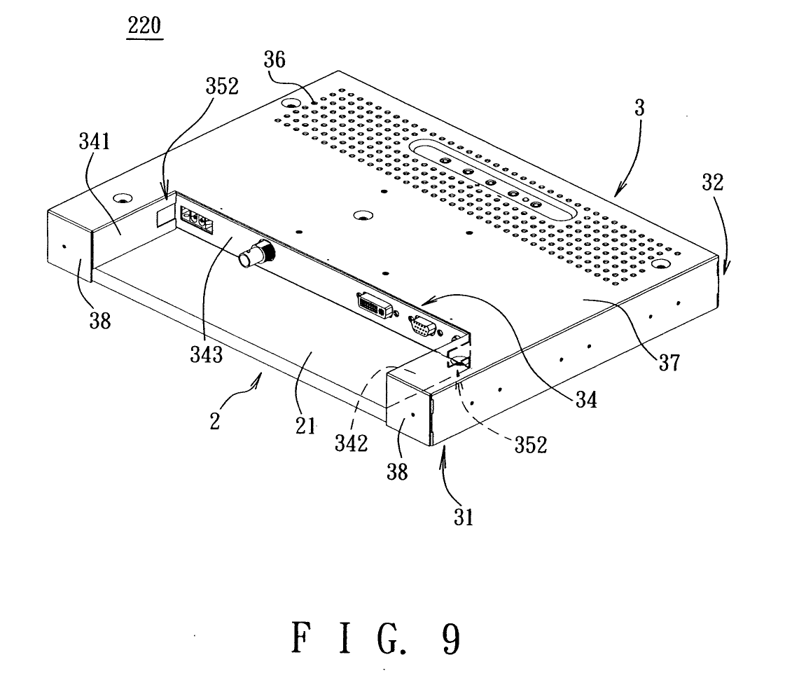

FIG. 9 illustrates a third preferred embodiment of a housing 220 for a display device according to the present invention. The overall construction of the housing 220 is generally similar to that of the second preferred embodiment. However, the design of the two air inlet holes 352 differs from that of the second preferred embodiment. In this embodiment, the two air inlet holes 352 are respectively formed in the first wall 341 and the second wall 342 and are formed by punching. A top end portion of the first wall 341 and a top end portion of the second wall 342 are respectively U-shaped with an opening that faces toward the third wall 343. The top end portion of the first wall 341 and the top end portion of the second wall 342 are respectively connected to two opposite end portions of the third wall 343 and respectively cooperate with the two opposite end portions of the third wall 343 to define the two air inlet holes 352.

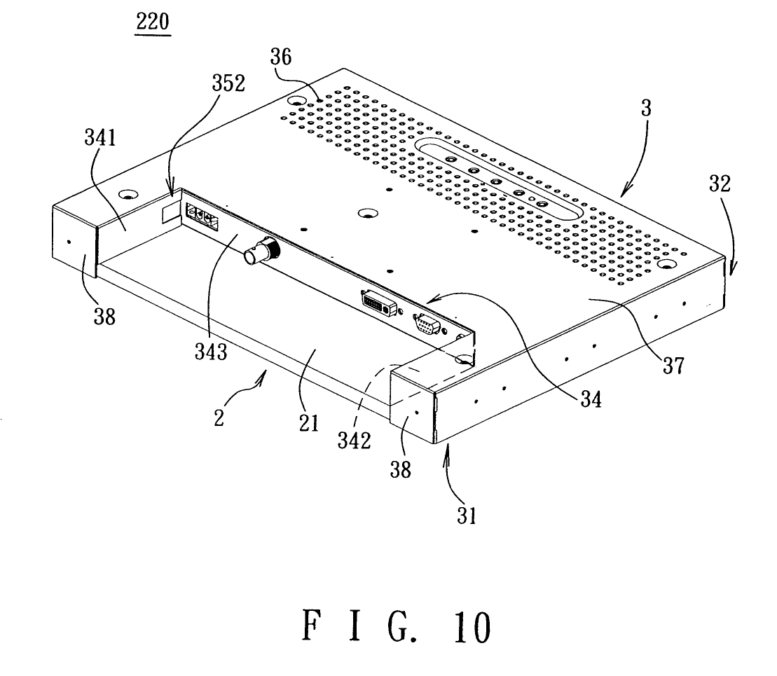

FIG. 10 illustrates a modification of the third preferred embodiment. The housing 220 of FIG. 10 is similar to that of FIG. 9, the main differences residing in that there is only one air inlet hole 352 in the rear housing part 3 of FIG. 10, and a top end portion of one of the first wall 341 and the second wall 342 is connected to the third wall 343 and cooperates with the third wall 343 to define the air inlet hole 352. The air inlet hole 352 is cooperatively defined by the first wall 341 and the third wall 343 in the embodiment of FIG. 10.

In sum, in the housing 200 of this invention, a top end portion of the first wall 341 and a top end portion of the second wall 342 are cut such that the top end portion of the first wall 341 and the top end portion of the second wall 342 cooperate with the two opposite end portions of the third wall 343 to define the two air inlet holes 35. In the housing 210 of this invention, the top end portion of the first wall 341 and the top end portion of the second wall 342 are respectively connected to the two opposite end portions of the third wall 343, and the two air inlet holes 351 are respectively formed in the first wall 341 and the second wall 342. In the housing 220 of this invention, the top end portion of the first wall 341 and the top end portion of the second wall 342 are respectively connected to the two opposite end portions of the third wall 343 and respectively cooperate with the two opposite end portions of the third wall 343 to define the two air inlet holes 352. Since the designs of the air inlet holes 35, 351, 352 are not restricted by safety considerations, the holes may be designed to be larger so as to increase air inflow and enhance the heat dissipating effect. In addition, the design of the air inlet holes 35 may reduce mold design and manufacturing costs, and the designs of the air inlet holes 351, 352 may prolong the service life of a mold. The objects of the present invention are thus met.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A housing for a display device, comprising:
a base housing part; and
a rear housing part installed on said base housing part and defining a receiving space, said rear housing part having a lower side portion, a recess portion formed in said lower side portion, at least one air inlet hole, an upper side portion, and a plurality of air outlet holes formed in said upper side portion, said recess portion having a first wall and a second wall relative to said first wall, said air inlet hole being formed in one of said first wall and said second wall, said air inlet hole being in fluid communication with said air outlet holes.

2. The housing for a display device as claimed in claim 1, wherein said recess portion is inverted U-shaped and has an opening that faces downwardly, said recess portion further having a third wall that faces said opening, said first wall, said second wall and said third wall being disposed transverse relative to said base housing part.

3. The housing for a display device as claimed in claim 2, wherein one of said first wall and said second wall has a top end portion connected to said third wall, and the other one of said first wall and said second wall has a top end portion that does not contact said third wall.

4. The housing for a display device as claimed in claim 2, wherein one of said first wall and said second wall has a top end portion connected to said third wall and cooperating with said third wall to define said air inlet hole.

5. The housing for a display device as claimed in claim 2, wherein said at least one air inlet hole has two air inlet holes formed respectively in said first wall and said second wall, said first wall having a top end portion, said second wall having a top end portion, said third wall having two opposite end portions, said top end portion of said first wall and said top end portion of said second wall being respectively connected to said two opposite end portions of said third wall and respectively cooperating with said two opposite end portions of said third wall to define said two air inlet holes.

6. The housing for a display device as claimed in claim 1, wherein said at least one air inlet hole has two air inlet holes formed respectively in said first wall and said second wall.

7. A housing for a display device, comprising:
a base housing part; and
a rear housing part installed on said base housing part and defining a receiving space, said rear housing part having a lower side portion, a recess portion formed in said lower side portion, at least one air inlet hole, an upper side portion, and a plurality of air outlet holes formed in said upper side portion, said recess portion having a first wall, a second wall and a third wall, said third wall having two opposite end portions, said first wall and said second wall being respectively disposed at positions corresponding to said two opposite end portions of said third wall, one of said first wall and said second wall being spaced apart from said third wall and cooperating with said third wall to define said air inlet hole, said air inlet hole being in fluid communication with said air outlet holes.

8. The housing for a display device as claimed in claim 7, wherein said recess portion is generally inverted U-shaped and has an opening that faces downward, said first wall and said second wall being disposed transverse relative to said base housing part.

9. The housing for a display device as claimed in claim 7, wherein said at least one air inlet hole has two air inlet holes, said first wall and said second wall being respectively spaced apart from said two opposite end portions of said third wall and respectively cooperating with said two opposite end portions of said third wall to define said two air inlet holes.
